(19) United States
(12) Patent Application Publication
(10) Pub. No.: US 2013/0309531 A1
(43) Pub. Date: Nov. 21, 2013

(54) WATER-COOLING PLATE UNIT FOR BATTERY SET

(71) Applicant: Tzu-Chin Chiu, New Taipei City (TW)

(72) Inventor: Tzu-Chin Chiu, New Taipei City (TW)

(73) Assignee: ASIA VITAL COMPONENTS CO., LTD., New Taipei City (TW)

(21) Appl. No.: 13/473,604

(22) Filed: May 17, 2012

(51) Int. Cl. H01M 10/50

(52) U.S. Cl. 429/72

(57) ABSTRACT

A water-cooling plate unit for a battery set includes a first plate, a second plate and a channel assembly. The first plate is covered by the second plate. The channel assembly is formed by a stamping process to have a first separating piece and a second separating piece. The first separating piece and the second separating piece are provided between the first plate and the second plate in such a manner that a channel is formed there between. The channel formed by the stamping process can make the whole water-cooling plate unit to have a compact size and a reduced product cost by using fewer materials. Further, the water-cooling plate unit can be assembly with the battery set and exhibit an improved heat-dissipating efficiency to the battery set.

### BACKGROUND OF THE INVENTION

1. Field of the Invention

The present invention relates to a water-cooling plate, and in particular to a water-cooling plate unit for a battery set, which has a reduced weight and a compact size to thereby decrease its cost by using fewer materials.

2. Description of Prior Art

In a situation that household AC power or DC power is not available, an additional battery is usually used for supplying electricity. For example, automobiles, lamps, electric tools, electronic apparatuses, communication apparatuses or heat exchange apparatuses are each additionally mounted with a battery for directly or indirectly supplying electricity.

During the operation of a battery set, electric discharge or charging occurs in batteries of the battery set. During the electric discharge or charging of a battery, electrons pass through filling materials in the battery, which causes the increase in the temperature of the battery. If the elevated temperature exceeds an allowable maximum working temperature, the power-supplying efficiency and the lifetime of the battery will be deteriorated greatly. Therefore, it is an important issue to dissipate the heat generated during the operation of the battery.

During the operation of a battery, a common heat-dissipating solution is to use a fan to generate airflow for air-cooling the battery. Alternatively, a water-cooling device may be used to carry the heat away by the flow of a working fluid therein. A common water-cooling device is configured to have a water-cooling plate unit configured to cooperate with a battery set. FIG. 1A is an exploded perspective view showing a conventional water-cooling plate unit. The water-cooling plate unit 1 includes a base 11 and a cover plate 12. Both the base 11 and the cover plate 12 are made by a CNC machining process or a gravity casting process. However, the CNC machining process or the gravity casting process can be only performed on a thicker plate in such a manner that one side of the base 11 is formed with a plurality of separating posts 111, and a plurality of a channel 112 are formed among the separating posts 111.

The cover plate 12 is also made by the CNC machining process or the gravity casting process to cover the separating posts 111 and the base 11. Thus, it is also necessary to process a thick plate so as to manufacture the cover plate 12. As a result, the minimum thickness of the thus-formed water-cooling plate unit 1 is 20mm, which makes the final product to have a larger thickness and weight as well as a higher production cost.

Please refer to FIG. 2B. The battery set 2 has a plurality of batteries 21. Since the water-cooling plate 1 has a larger thickness, the battery set 2 would have a huge volume if such a thick water-cooling plate unit 1 is to be inserted between the adjacent two batteries 21. Thus, the water-cooling plate unit 1 cannot be inserted between the batteries 21, and the only possible solution is to provide aluminum pieces 22 between adjacent two batteries 21 in such a manner that the aluminum pieces 22 are thermally adhered to the batteries 21 respectively. Then, the water-cooling plate unit 1 is thermally adhered to an end of each aluminum piece 22. In this way, the heat generated by the batteries 21 can be transferred from the aluminum pieces 22 to the water-cooling plate unit 1 and finally carried away by the working fluid in the water-cooling plate unit 1. However, the heat-dissipating efficiency of such an indirect heat transfer via the aluminum pieces 22 is insufficient. Further, providing the aluminum pieces 22 in the battery set 2 inevitably raises the product cost. Therefore, the conventional water-cooling plate unit 1 has the following problems: (1) larger thickness and weight; (2) higher production cost; and (3) poor heat-dissipating efficiency.

In view of the above, it is an important issue for the present inventor and the manufacturers in this field to solve the problems of prior art.

### SUMMARY OF THE INVENTION

In order to solve the above problems, an objective of the present invention is to provide a water-cooling plate unit for a battery set, which has a reduced weight, a compact size, and a decreased cost.

Another objective of the present invention is to provide a water-cooling plate unit for a battery set, which has an improved heat-dissipating efficiency.

In order to achieve the above objective, the present invention is to provide a water-cooling plate unit for a battery set, including a first plate, a second plate and a channel assembly. The first plate has a first side surface and a second side surface. The second plate has a third plate and a fourth side surface. The third side surface is covered by the second side surface of the first plate. The channel assembly is formed by a stamping process to have a first separating piece and a second separating piece. The first separating piece and the second separating piece are provided between the first plate and the second plate in such a manner that a channel is formed between the second side surface and the third side surface for allowing a working fluid to flow through. The channel formed by the stamping process between the first separating piece and the second separating piece can make the whole water-cooling plate unit to have a compact size and a reduced product cost by using fewer materials. Further, the water-cooling plate unit can be assembly with the battery set and exhibit an improved heat-dissipating efficiency to the battery set. Therefore, the present invention has the following advantages: (1) compact size and reduced weight; (2) reduced production cost by using fewer materials; and (3) improved heat-dissipating efficiency.

### BRIEF DESCRIPTION OF THE DRAWINGS

FIG. 1A is an exploded perspective view showing a conventional water-cooling plate unit;

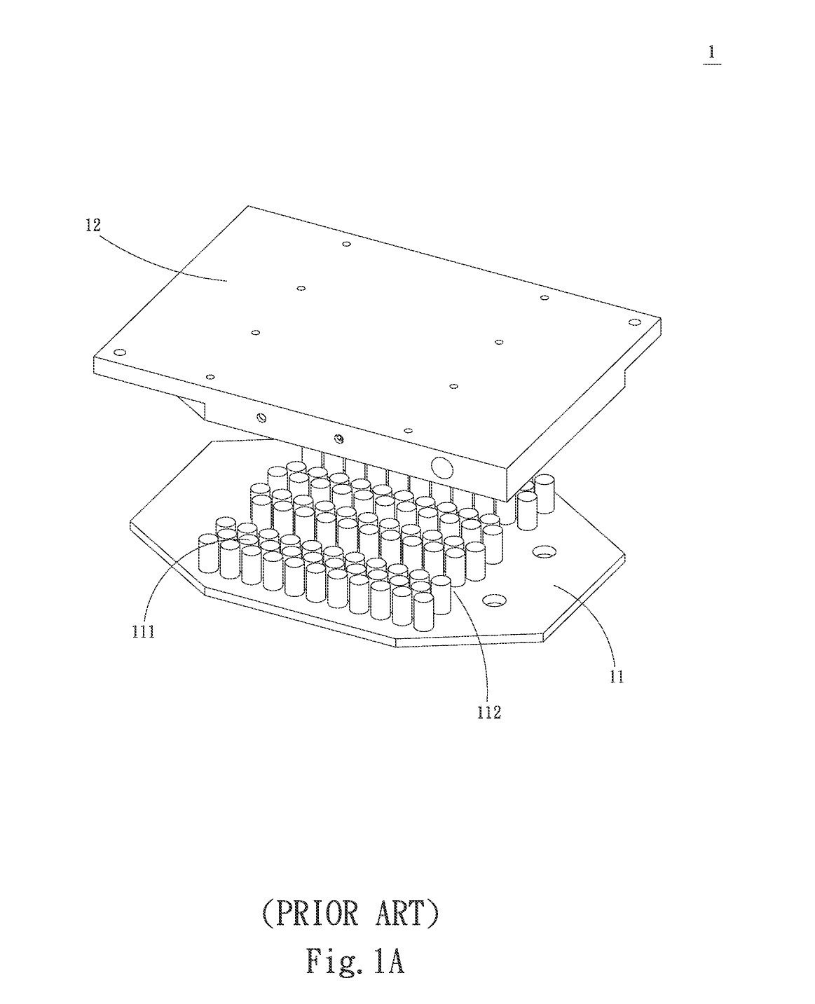

FIG. 1B is a schematic view showing the operation of the conventional water-cooling plate unit;

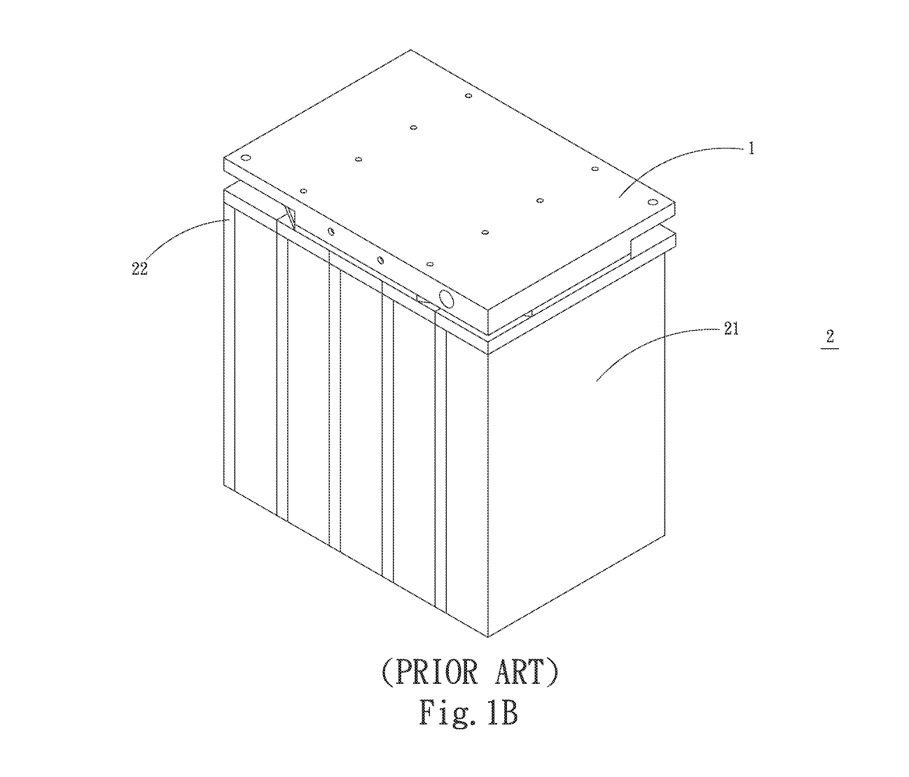

FIG. 2 is an exploded perspective view of a first embodiment of the present invention;

FIG. 3 is an assembled perspective view of the first embodiment of the present invention;

FIG. 4 is a schematic view showing the operation of the first embodiment of the present invention;

FIG. 5 is an exploded perspective view of a second embodiment of the present invention; and

FIG. 6 is an exploded perspective view of a third embodiment of the present invention.

### DETAILED DESCRIPTION OF THE INVENTION

The above objectives and structural and functional features of the present invention will be described in more detail with reference to preferred embodiment thereof shown in the accompanying drawings

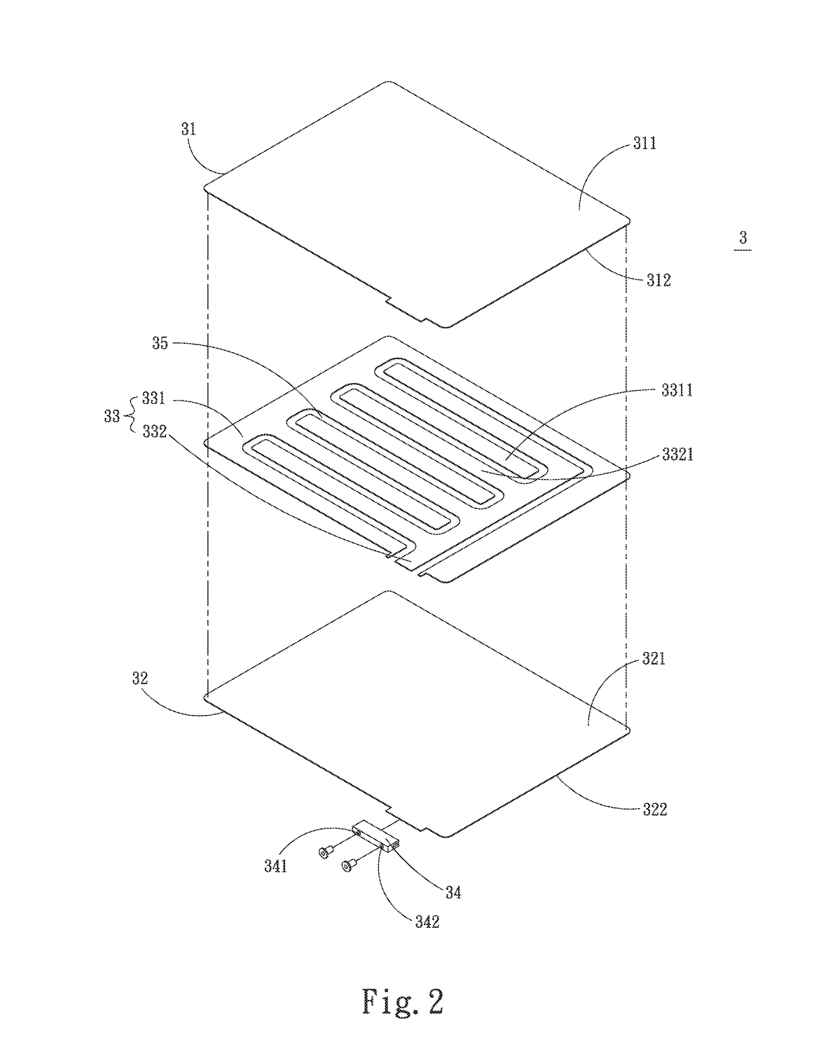

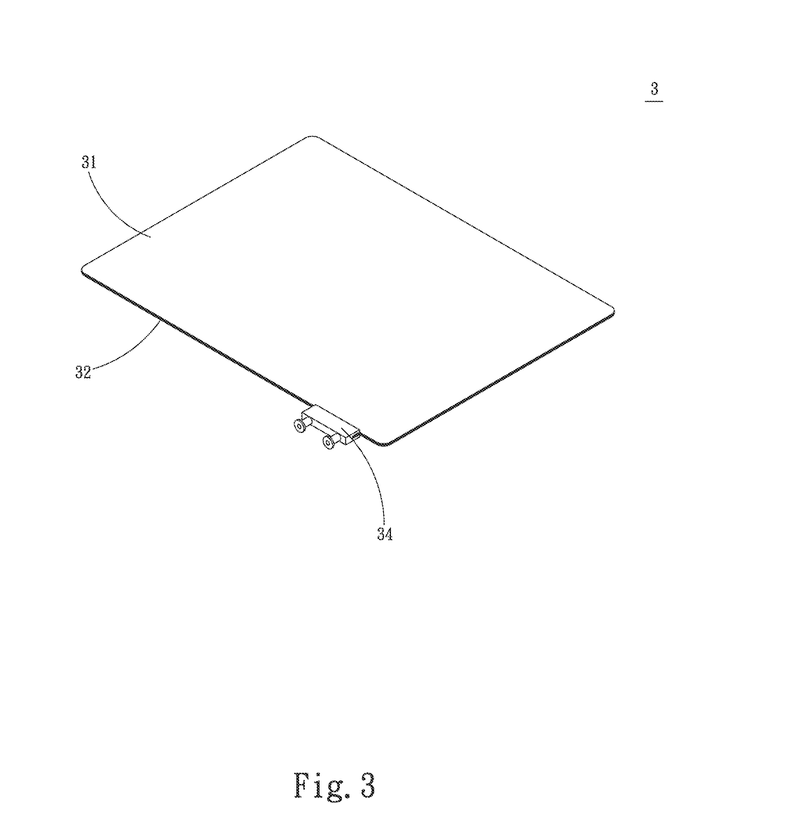

Please refer to FIGS. 2 and 3, which are an exploded perspective view and an assembled perspective view showing the water-cooling plate unit for a battery set according to the first embodiment of the present invention. As shown in these drawings, the water-cooling plate unit 3 includes a first plate 31, a second plate 32, a channel assembly 33, and a connector set 34. Both sides of the first plate 31 are formed with a first side surface 311 and a second side surface 312. Both sides of the second plate 32 are formed with a third side surface 321 and a fourth side surface 322. The third side surface 321 is covered by the second side surface 312 of the first plate 31.

The channel assembly 33 is formed by a stamping process to have a first separating piece 331 and a second separating piece 332. The first separating piece 331 and the second separating piece 332 are provided with a plurality of first extending portions 3311 and a plurality of second extending portions 332 that are staggered to each other. The first separating piece 331 and the second separating piece 332 are provided between the first plate 31 and the second plate 32. In the present embodiment, the first separating piece 331 and the second separating piece 332 are formed separately and then soldered to the first plate 31 and the second plate 32 after their formation. After the first plate 31 and the second plate 32 are soldered and sealed together, a channel 35 is formed between the first separating piece 331 and the second separating piece 332 and between the second side surface 312 and the third side surface 321. The channel 35 is assembled with the connector set 34 having an inlet port 341 and an outlet port 342. The inlet port 341 and the outlet port 342 are in communication with two openings of the channel 35.

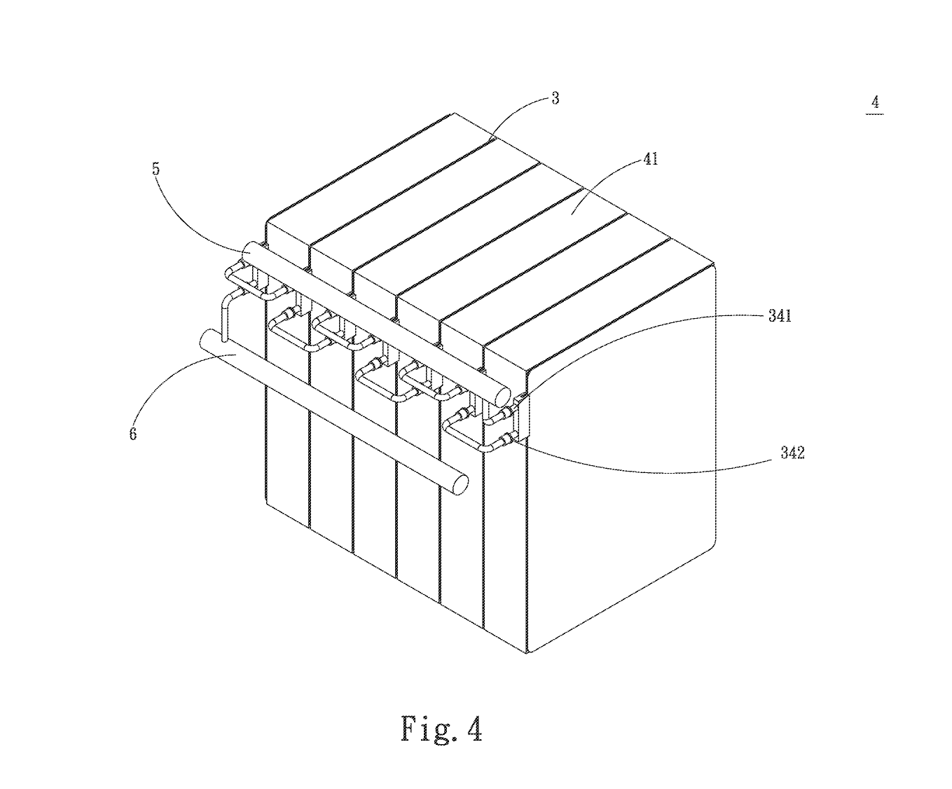

Please also refer to FIG. 4, which is a schematic view showing the operation of the water-cooling plate unit for a battery set according to the present invention. As shown in this figure, the water-cooling plate unit 3 is assembled with a battery set 4 having a plurality of batteries 41. A space is formed between each battery 41 for accommodating the water-cooling plate unit 3. The water-cooling plate unit 3 is disposed in this space in such a manner that both side surfaces of the water-cooling plate unit 3 are adhered to the surfaces of adjacent two batteries 41. By this arrangement, the water-cooling plate unit 3 is disposed between adjacent two batteries 41 of the battery set 4. The channel assembly of the water-cooling plate unit 3 is formed by a stamping process, so that a CNC machining process or a gravity casting process is not needed any more. In this way, the present invention can be made compact with a reduced production cost by using fewer materials.

Each water-cooling plate unit 3 is in communication with an inlet pipe 5 via the inlet port 341 of the connector port 34. The outer ports 342 are in communication with an outlet pipe 6. Therefore, when the battery 41 of the battery set 4 generates heat, since the working fluid coming from the inlet pipe 5 flows into the inlet port 341 and then into the channel 35 of the water-cooling plate unit 3, the water-cooling plate unit 3 is adhered to the surfaces of adjacent two batteries 4, the working fluid in the water-cooling plate unit 3 can directly absorb the heat generated by the battery 41, so that the heat-dissipating efficiency of the water-cooling plate unit 3 is improved greatly.

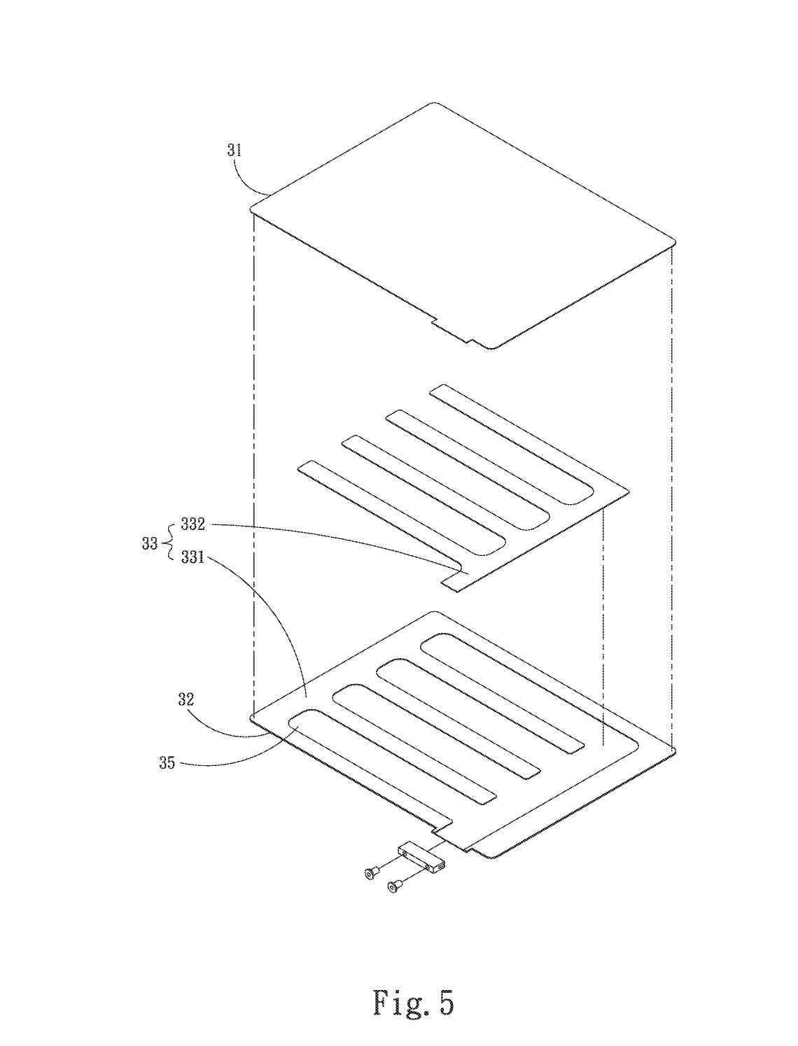

Please refer to FIG. 5, which is an exploded perspective view showing the water-cooling plate unit for a battery set according to the second embodiment of the present invention. As shown in this figure, in the present embodiment, the channel assembly 33 is similarly formed by a stamping process to have a first separating piece 331 and a second separating piece 332. The first separating piece 331 is directly formed by a stamping process, while the second separating piece 332 is formed by a stamping process in one of the first plate 31 and the second plate 32. In the present embodiment, the second separating piece 332 is formed by a stamping process in the second plate 32. The first separating piece 331 is separately formed and then soldered to the first plate 31 and the second plate 32. After the first plate 31 and the second plate 32 are soldered and sealed together, a channel 35 is formed between the first separating piece 331 and the second separating piece 332 as well as between the second side surface 312 and the third side surface 321. The channel assembly of the water-cooling plate unit 3 is formed by a stamping process to have the channel 35, and thus a CNC machining process or a gravity casting process is not needed any more. In this way, the present invention can be made compact with a reduced production cost by using fewer materials.

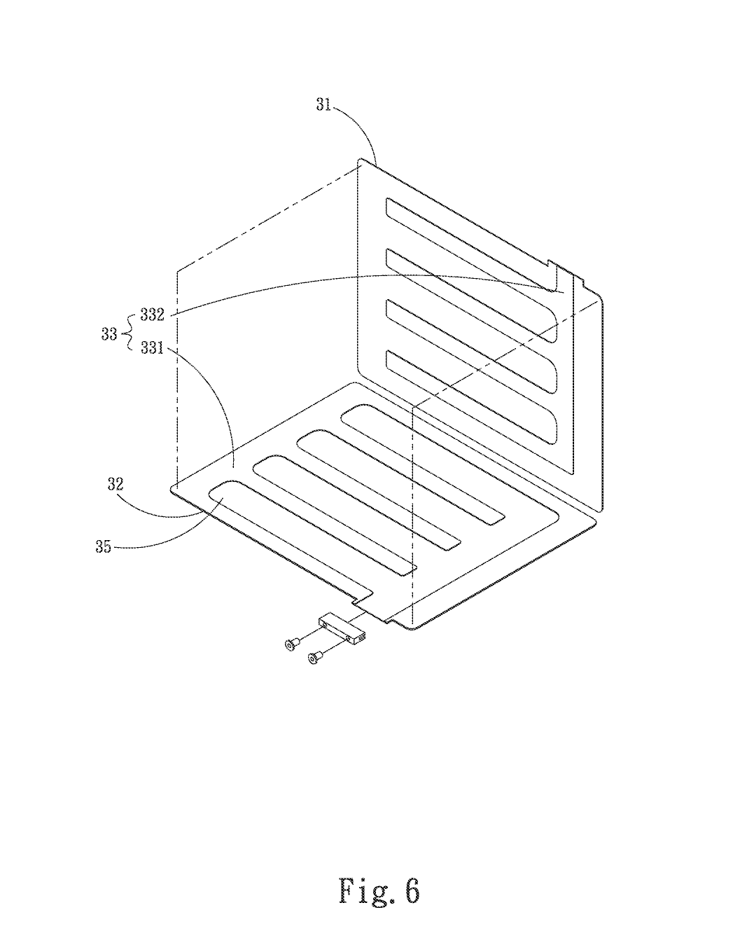

Please refer to FIG. 6, which is an exploded perspective view showing the water-cooling plate unit for a battery set according to the third embodiment of the present invention. As shown in this figure, in the present embodiment, the channel assembly 33 is similarly formed by a stamping process to have a first separating piece 331 and a second separating piece 332. The first separating piece 331 is formed by a stamping process in any one of the first plate 31 and the second plate 32, while the second separating piece 332 is formed by a stamping process in the other of the first plate 31 and the second plate 32. After the first separating piece 331 and the second separating piece 332 are formed, they are soldered and sealed to the first plate 31 and the second plate 32. A channel 35 is formed between the first separating piece 331 and the second separating piece 332 as well as between the second side surface 312 and the third side surface 321. The channel assembly of the water-cooling plate unit 3 is formed by a stamping process to have a channel 35, and thus a CNC machining process or a gravity casting process is not needed any more. In this way, the present invention can be made compact with a reduced production cost by using fewer materials.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A water-cooling plate unit for a battery set, including:
a first plate having a first side surface and a second side surface;
a second plate having a third side surface and a fourth side surface, the third side surface being covered by the second side surface of the first plate; and
a channel assembly formed by a stamping process to have a first separating piece and a second separating piece, the first separating piece and the second separating piece being disposed between the first plate and the second plate, a channel being formed between the first separating piece and the second separating piece as well as between the second side surface and the third side surface.

2. The water-cooling plate unit for a battery set according to claim 1, wherein the channel assembly is formed by the stamping process to have the first separating piece and the second separating piece, the first separating piece and the second separating piece are separately provided and soldered to the first plate and the second plate in a staggered manner.

3. The water-cooling plate unit for a battery set according to claim 1, wherein the channel assembly is formed by the stamping process to have the first separating piece, the second separating piece is formed by the stamping process in any one of the first plate and the second plate, the first separating piece is separately provided and soldered to the first plate and the second plate.

4. The water-cooling plate unit for a battery set according to claim 1, wherein the channel assembly is formed by the stamping process to have the first separating piece and the second separating piece, the first separating piece is formed by the stamping process in any one of the first plate and the second plate, the second separating piece is formed by the stamping process in the other of the first plate and the second plate.

5. The water-cooling plate unit for a battery set according to claim 1, further including a connector set having an inlet port and an outlet port in communication with two openings of the channel.

6. The water-cooling plate unit for a battery set according to claim 1, wherein the battery set has a plurality of batteries, the water-cooling plate unit is adhered to two side surfaces of adjacent two batteries.

7. The water-cooling plate unit for a battery set according to claim 5, wherein the inlet port is in communication with an inlet pipe, and the outlet port is in communication with an outlet pipe.

8. The water-cooling plate unit for a battery set according to claim 6, wherein the first side surface and the fourth side surface are adhered to two surfaces of adjacent two batteries.

9. The water-cooling plate unit for a battery set according to claim 1, wherein the first separating piece and the second separating piece are provided with a plurality of first extending portions and a plurality of second extending portions.
